(19) United States
(12) Patent Application Publication
(10) Pub. No.: US 2010/0030601 A1
(43) Pub. Date: Feb. 4, 2010

(54) PRODUCT SUSTAINABILITY ASSESSMENT

(75) Inventors: Clement Warther, Boulogne-Billancourt (FR); Gerald Alexander Rebitzer, Winterthur (CH)

Correspondence Address: PEARNE & GORDON LLP, 1801 EAST 9TH STREET, SUITE 1200, CLEVELAND, OH, 44114-3108, US

(73) Assignee: ALCAN PACKAGING FLEXIBLE FRANCE, Courbevoie (FR)

(21) Appl. No.: 12/441,170

(22) PCT Filed: Oct. 15, 2007
(86) PCT No.: PCT/IB07/55373

§ 371 Date: Mar. 13, 2009

Related U.S. Application Data
(60) Provisional application No. 60/851,317, filed on Oct. 13, 2006.

(51) Int. Cl. G06Q 10/00

(52) U.S. Cl. 705/7

(57) ABSTRACT

There is described herein a method for evaluating the relative sustainability of a product, addressing the complete physical life cycle, the method comprising: defining a product within a product family wherein products perform equivalent functions; defining a set of environmental, social, and economic criteria; selecting a product from said product family as a baseline for comparison; and scoring said product compared to said baseline for each of said criteria.

### CROSS-REFERENCE TO RELATED APPLICATIONS

This application claims priority of U.S. Provisional Patent Application bearing Ser. No. 60/851,317, filed on Oct. 13, 2006, the contents of which are hereby incorporated by reference.

### TECHNICAL FIELD

The present invention relates to the field of product sustainability, and more specifically, to a tool and method used to assess the complete life cycle of existing and potential products.

### BACKGROUND

The product life cycle refers to the succession of physical stages a product goes through. Product life cycle management is the succession of strategies used by management for addressing all stages of a product life cycle.

In the field of product life cycle management, various tools are currently available to assess different aspects of a product. For example, US Patent Application 2006/0100897 describes a system for assessing and improving social responsibility of a business. US Patent Application 2003/0187722 describes a tool that considers quality and environmental factors in supporting product life cycle planning. US Patent Application 2001/0029461 also describes a tool which considers the environmental aspect for the whole life cycle of a product, while US Patent Application 2005/0096951 addresses the needs encountered for products developed from collaborative efforts between various entities.

While the above tools may be useful for assessing individual aspects of the life cycle of a product, they do not provide the comprehensive assessment that will consider multiple aspects, both qualitatively and quantitatively, of a product and thereby allow a user to evaluate the sustainability of its complete life cycle.

### SUMMARY

The present invention considers that sustainability of a product can be assessed by considering three general aspects. These are economic (wise use of financial resources, economic health, etc), social (respect for people, human rights, health, safety, impacts on communities, etc), and environmental aspects (respect for the planet, wise stewardship of natural resources, etc). To properly assess product sustainability, all three of these components are considered in order to reduce risks and impacts and/or determine future competitive advantages.

In accordance with a first broad aspect of the present invention, there is provided a method for evaluating sustainability of a product, the method comprising: defining a product within a product family wherein products perform equivalent functions; defining a set of environmental, social, and economic criteria; selecting a product from said product family as a baseline for comparison; and scoring said product compared to said baseline for each of said criteria.

In one embodiment of the present invention, a sustainability profile is derived by providing one score for each of the environmental, social, and economic criteria, which themselves are derived by averaging (with weighting factors) each criterion over the relevant stages of the life cycle. In another embodiment of the present invention, an overall sustainability index is derived by first calculating an average score for each of the three general aspects assessed (environmental, social, and economic), with weights assigned to each average score of a criterion. In a second step, the single-score sustainability index is calculated by averaging the scores for each general aspect, with weighting factors for each aspect.

### BRIEF DESCRIPTION OF THE DRAWINGS

Further features and advantages of the present invention will become apparent from the following detailed description, taken in combination with the appended drawings, in which:

FIG. 1 is a flow chart of a method corresponding to an embodiment of the present invention.

FIGS. 2A-2F are tables that present examples of criteria as well as life cycle stages for which the product is scored against the baseline. While some criteria are directly scored in a qualitative way, others are indirectly and quantitatively scored using system parameters, databases, and aggregation steps via indicators.

FIG. 3 is a graph showing an example of presenting environmental indicators related to the quantitative environmental criteria, based on life cycle impact category indicator results, the indicators representing environmental criteria, for comparing a product to a baseline.

FIG. 4 is a table illustrating an example of scoring the different criteria for each life cycle step.

FIG. 5 is an exemplary graph representing the sustainability profile for the relevant life cycle steps of the exemplary embodiment.

FIG. 6 illustrates an example of presenting the aggregated results within the three pillars of sustainability and the overall normalized sustainability index, also showing specific strengths (green flags) and weaknesses (red flags) of the product compared the baseline; and

It will be noted that throughout the appended drawings, like features are identified by like reference numerals.

### DETAILED DESCRIPTION

One of the areas in which the product life cycle management tool may be used is a field in which a plurality of products are to be assessed and compared for a plurality of criteria, such as, for example, the field of packaging. While the detailed description will be made with respect to a packaging field environment, including packaging specific criteria, life cycle stages, and parameters, it is to be understood that the description as set forth below is intended to be illustrative and does not limit the invention to the precise form disclosed.

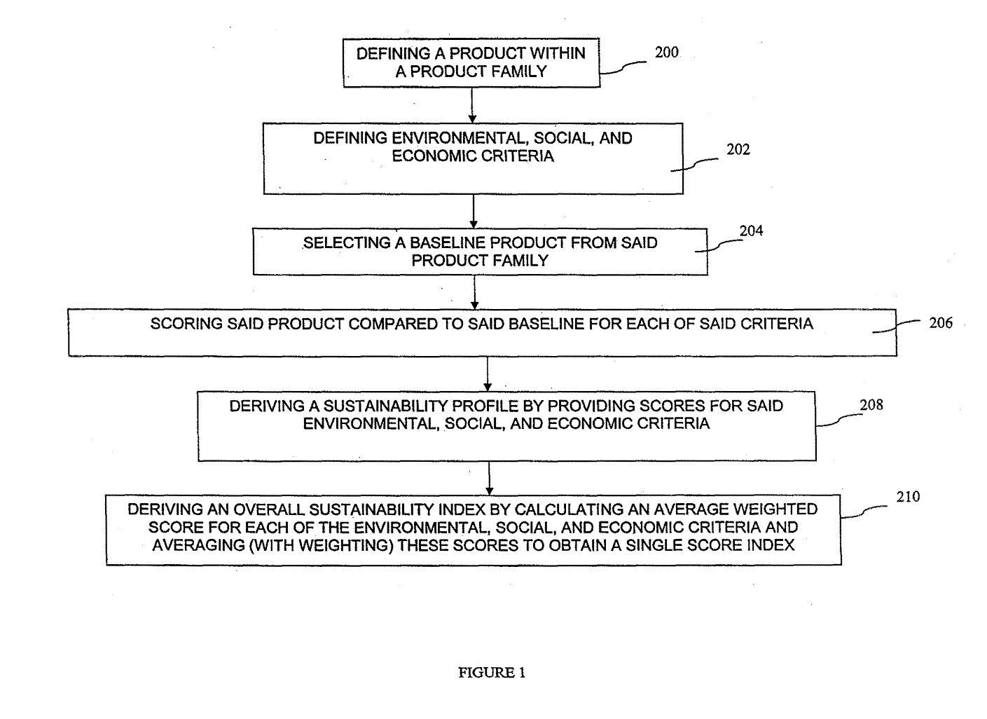

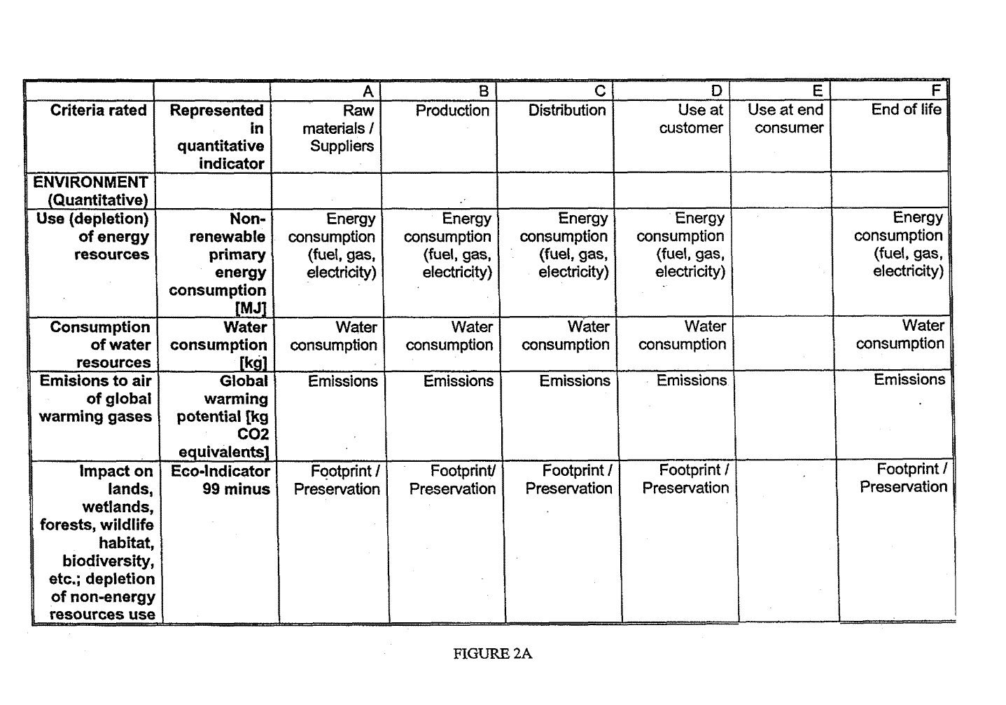

As illustrated in FIG. 1, an embodiment of the method of the present invention includes the following steps. First, a product family is defined 200. The tool allows comparing products that perform equivalent functions and which are therefore grouped in a same product family. For example, for packing 250 g of retorted pet food, alternative packaging devices, such as a can, a pouch, or a tray, can be compared against each other. Different comparable products, such as the different packaging devices, form a family. A set of environmental, social, and economic criteria is defined 202. A baseline product from the same product family is selected as a “baseline” 204. All other products are compared against it. All scoring is relative to the baseline. A product being compared is assigned a score 206 in comparison to the baseline product for each criterion or the aggregated representation of each criterion (in the case of some quantitative criteria).

In one embodiment, two additional steps may be added to the method. A sustainability profile may be derived by providing one score each, or for the representation of several criteria via one or more indicators, for the environmental, social, and economic criteria 208. An overall sustainability index may also be derived by calculating an average weighted score for each of the environmental, social, and economic general aspects and then computing a weighted average of the environmental, social, and economic average scores 210. All steps listed above will be described in more detail below.

The results of the tool can comprise any or all of: a detailed quantitative environmental assessment; a detailed quantitative assessment of social aspects, a detailed quantitative assessment of economic aspects, a detailed qualitative environmental assessment; a detailed qualitative assessment of social aspects; a detailed qualitative assessment of economic aspects; a sustainability profile (overview of strengths and weaknesses compared to a baseline product); and a sustainability index aggregating all of the aforementioned sustainability aspects.

For the environmental assessments, the general principles and the framework follow the requirements formulated in ISO 14040: 2006. Due to a lack of standards for the social and economic assessments along the life cycle, these assessments are also carried out according to the principles for the environmental assessment, as far as possible and appropriate.

One principle of the approach is that all assessments are relative, i.e. relative to a baseline product. Before an assessment can be carried out, one has to define a product family and the market in which the product will be used, which defines the function or performance of the product system. Products with equivalent functions (e.g. packaging for carbonated beverages for the Western-European market) can be assessed within a product family. For each product family, one or more baselines are defined, each with a quantified value (reference flow) that represents the function in a quantified form. (e. g. packaging of 0.5 liters of carbonated beverage). Function and reference flow together represent the functional unit, which is the basis for comparison and defined as follows: Quantified performance of a product system for use as a reference unit [ISO 14040: 2006]. Each baseline resembles an existing standard or hypothetical product, against which the packaging solutions to be assessed are compared.

This concept ensures that a baseline and the products assessed compared to this baseline fulfill the same functional unit. The direct use of the reference flow has been chosen over the use of the functional unit, as it is less abstract, and allows for better usability of this concept by the intended audience. In some cases the reference flow can also be defined directly as a flow of area (e. g. m² of flexible packaging laminate) or similar units. For instance, a comparison may be made between packaging laminates with the same function in regards to product properties and quantity, e.g. two laminates may be compared based on the reference flow of an area of 100 m² if the required areas for the assessed packaging alternatives are identical. Nevertheless, comparisons based directly on the functional unit concept may be used instead of the reference flow with the same desired result.

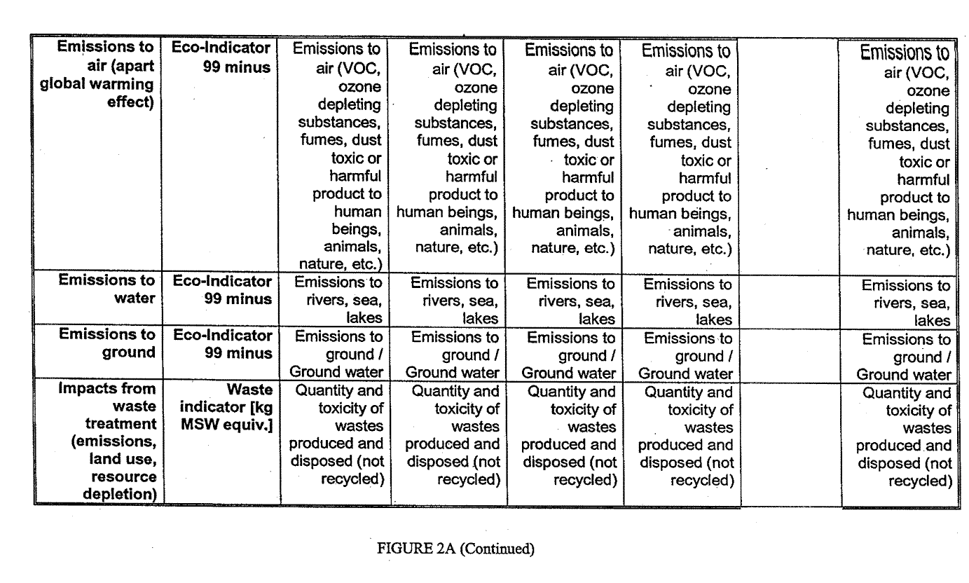

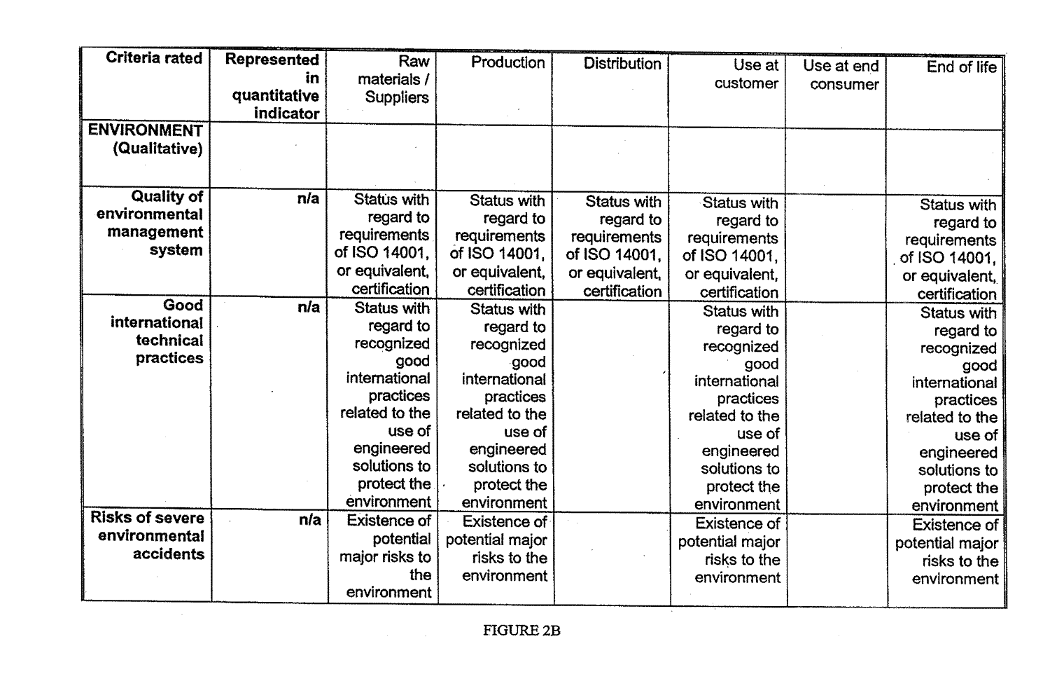

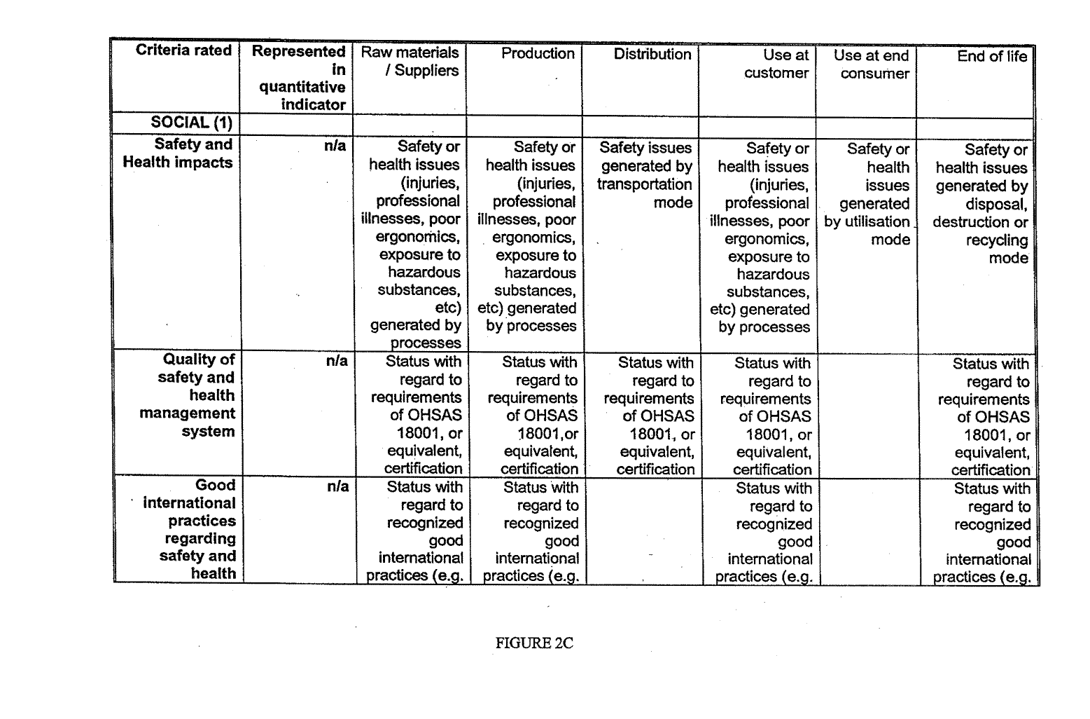

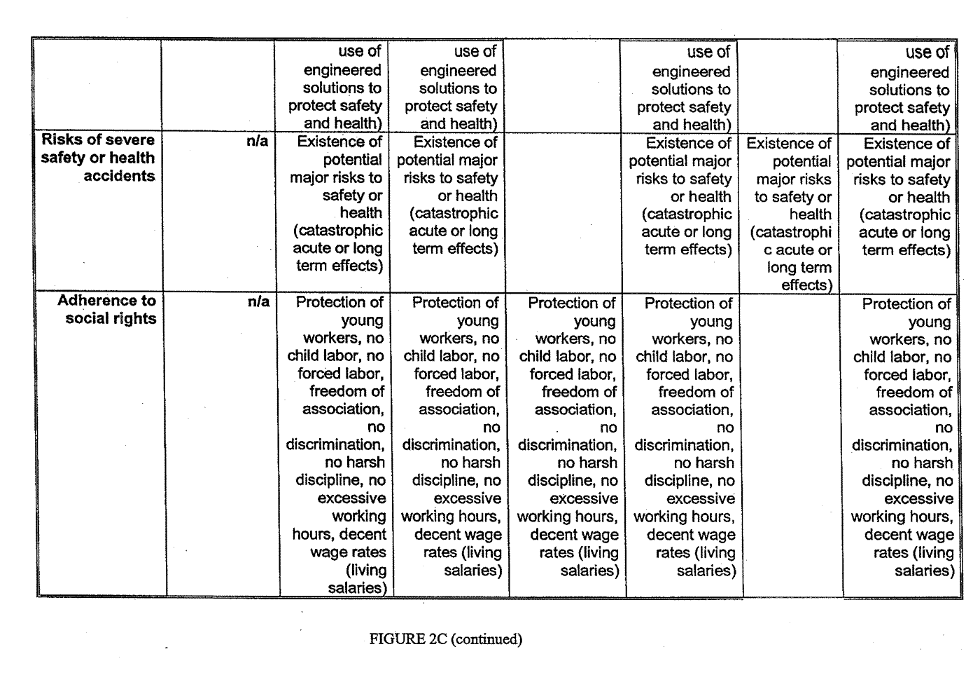

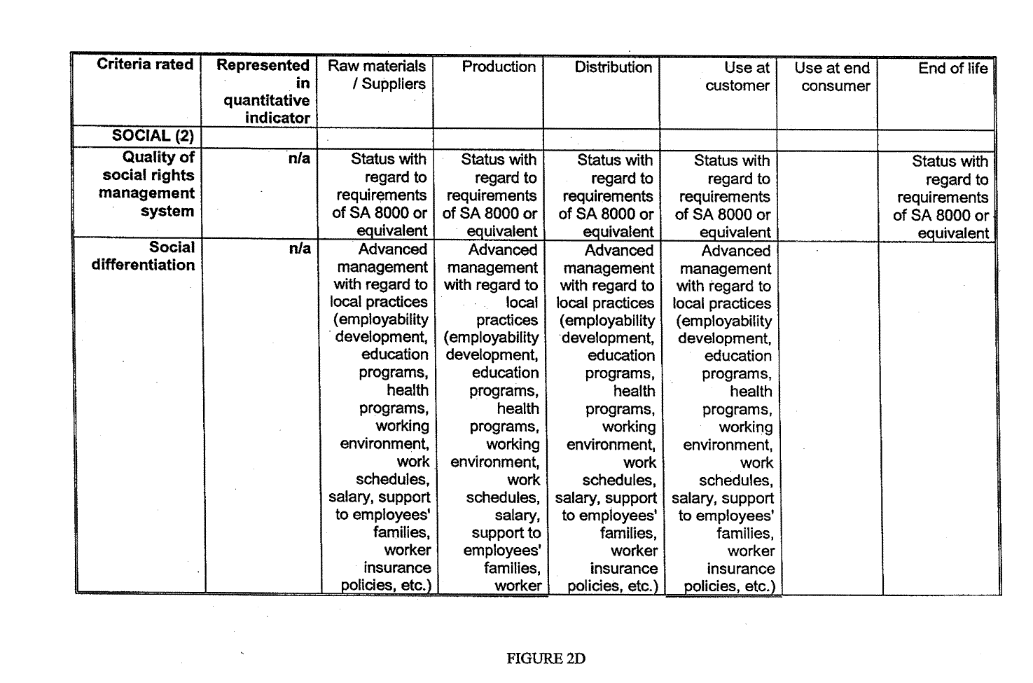

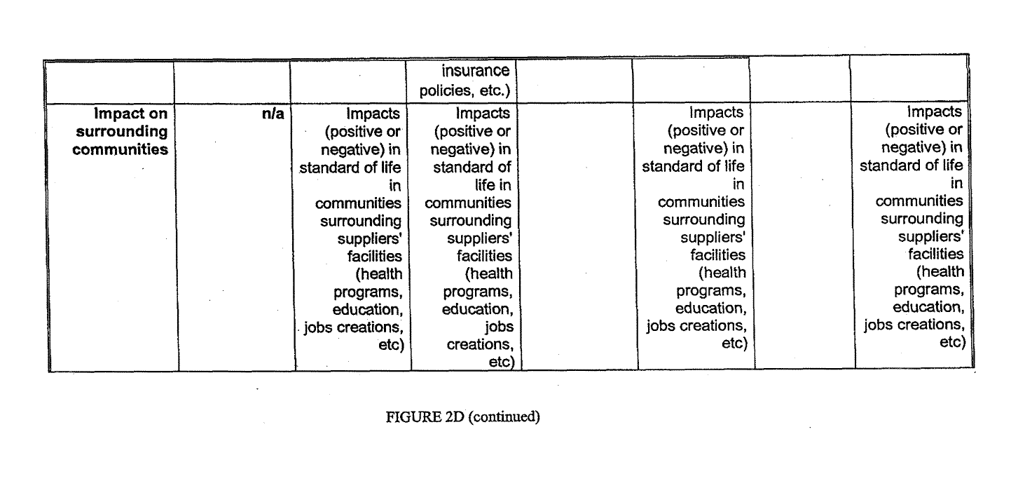

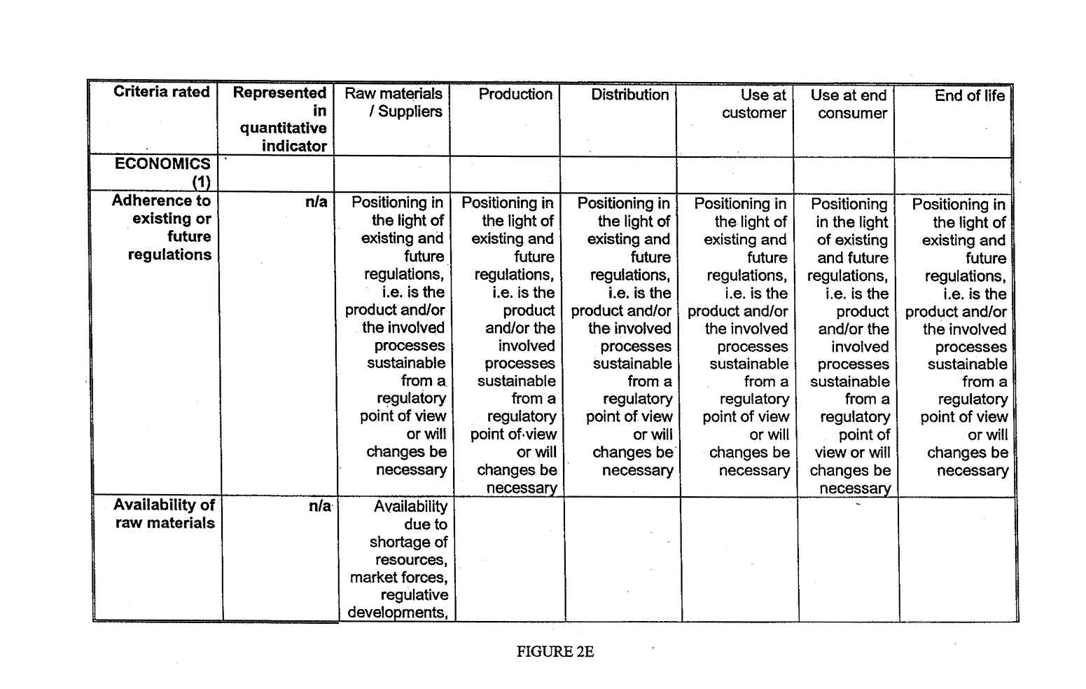

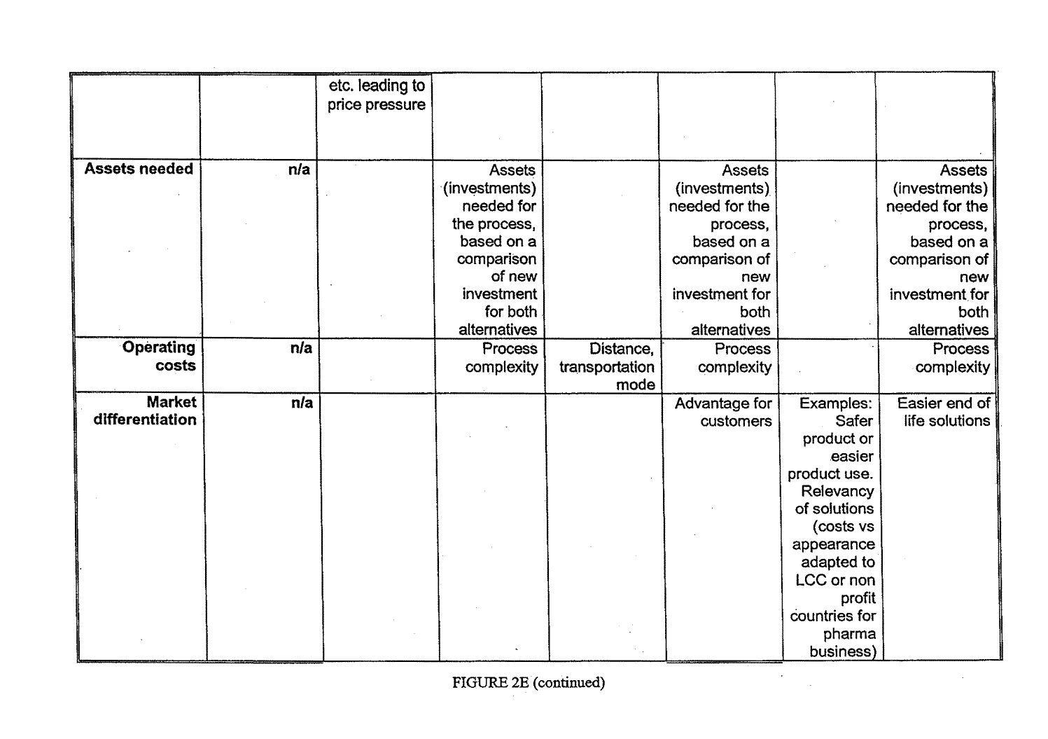

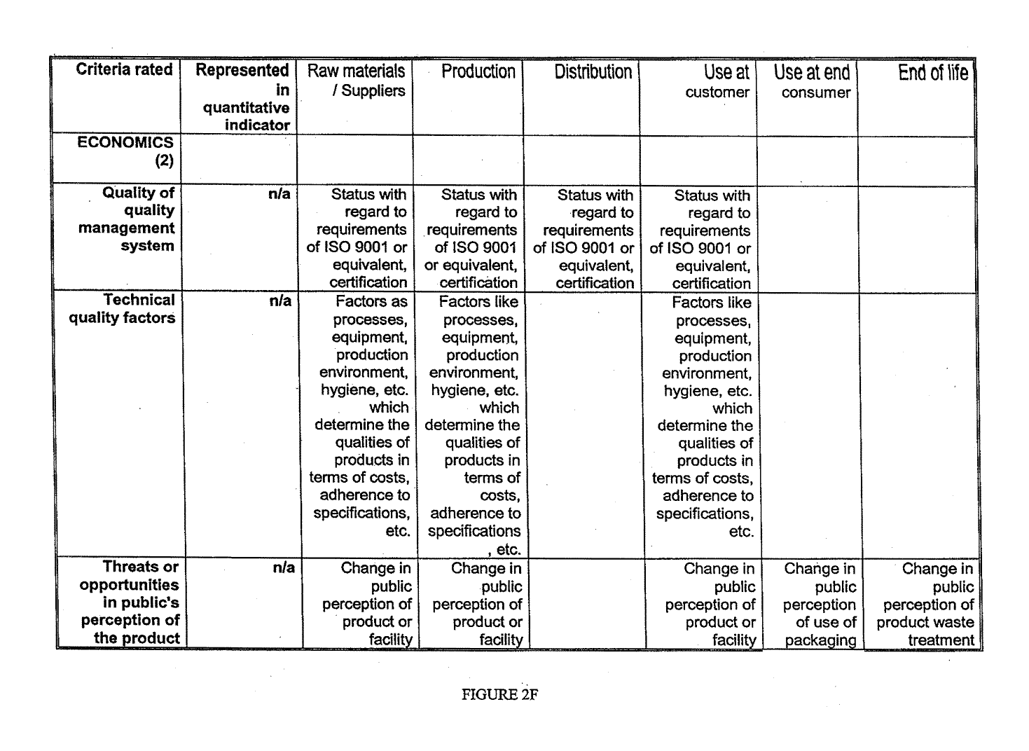

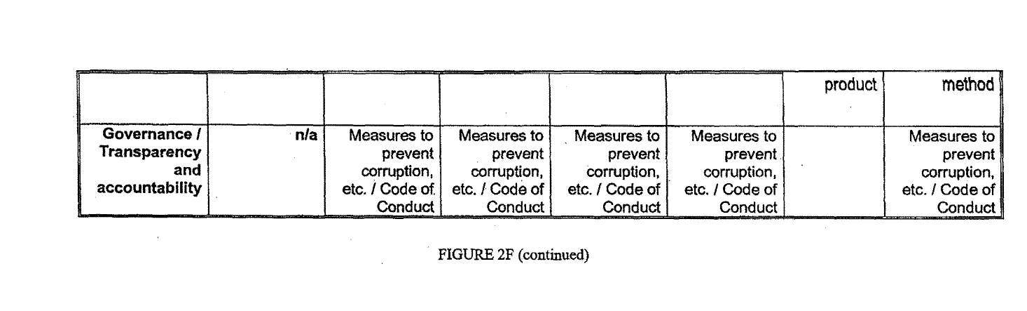

For the reference flow of each product the assessment is carried out for all defined criteria (see examples in the tables illustrated in FIGS. 2A to 2F). All intermediate results and intermediate aggregation steps can be separately displayed, so that the user or the expert can go back and find explanations for results.

The quantitative environmental assessment is carried out according to the principles of International Standard ISO 14040: Environmental management—Life cycle assessment—Principles and framework. Geneva, Switzerland: International Organization for Standardization, 2006. This standard may be replaced by any other standard. The environmental assessment may also have a qualitative component. The assessments of the social and economic aspects are based on the same principles, though often involving more qualitative criteria. Some of the defined criteria are mandatory and some are optional in order to ensure that the criteria set represents all relevant sustainability aspects as good as possible according to the scientific state of the art (see examples in the tables illustrated in FIGS. 2A to 2F).

Based on the definition of a baseline, a product to be compared and the corresponding reference flows, the input and output material and energy flows, or the corresponding linked processes, for the main process chain (raw material inputs from suppliers, ancillaries and energy use, as well as production emissions and waste, the equivalent data for customer production (as well as their customers if relevant) and end-of-life treatment, etc.) are defined. Additionally, transport means and transport distances, from delivering the product to the customer, for example, as well as other processes relevant for the life cycle, may be defined. This data is then linked to databases that deliver impact category indicator results for all inputs and outputs or the corresponding processes. The databases contain life cycle impact category indicator results based on life cycle inventories [ISO 14040: 2006] for the production of the different inputs and generation of the different outputs as well as for specific processes (e. g. waste treatment of a particular plastic material).

These indicators are aggregated over the life cycle (for each indicator), and can be represented by a display of the contributions of the several life cycle stages (see FIG. 3) and uncertainties may also be taken into account. The product and the baseline are quantitatively compared based on these indicators. Normalization according to [ISO 14040: 2006], followed by a further aggregation (e.g. calculating the sum of the normalized indicators with or without weighting) may be applied if desired or if otherwise no clear scoring (see below) can be achieved.

From the detailed assessment, an overall scoring of the quantitative environmental aspects of the product relative to the baseline is conducted. In one exemplary embodiment of the invention, the scoring is done according to the following proposed scheme. Though not illustrated in this particular example, additional uncertainty ranges might be taken into account.

−2: product has calculated potential environmental indicators, which are 25% or more higher than those of the baseline.

−1: product has calculated potential environmental indicators, which are 10% or more higher than those of the baseline, but less than 25% higher.

0: product has calculated potential environmental indicators, which differ less than 10% from those of the baseline.

+1: product has calculated potential environmental indicators, which are 10% or more lower than those of the baseline, but less than 25% lower.

+2: product has calculated potential environmental indicators, which are 25% or more lower than those of the baseline.

By definition, the baseline has the scoring “0”. The overall differences of the calculated potential environmental impacts are derived from a procedure such as given in the following example, where uncertainty ranges may also be taken into account. Other procedures are also possible:

Determination of the differences for the indicator that is considered most important and/or representative and preliminary determination of the scoring (−2, −1, 0, 1, 2) according to the scheme above.

Check if any of the other indicators, including the aggregated indicator, as explained above, gives a reversal of the ranking (change of sign from + to − or vice versa).

If there is no reversal of the ranking in any of the indicators, the preliminary scoring from a) is the final scoring for the quantitative environmental assessment.

If there is a reversal identified in b), then the scoring is derived based on a comparison of the aggregated normalized indicators of the product and the baseline.

This scoring then represents the overall assessment of the quantified environmental impacts. The other environmental criteria (not quantified, i.e. not automatically calculated, see examples in FIG. 2B) are directly scored by the user. The user decides if there are practically no differences between baseline and product for a criterion (scoring 0), if there are significant, but not huge differences (scoring −1 or +1) or if there are huge differences (scoring −2 or 2). As a result, one obtains several qualitative scores for one criterion (one score for each assessed life cycle stage), each being an integer in the interval [−2, 2]. It has to be noted that the scoring scheme ranging from −2 to +2 is a specific embodiment of the invention, and other scoring systems can also be employed.

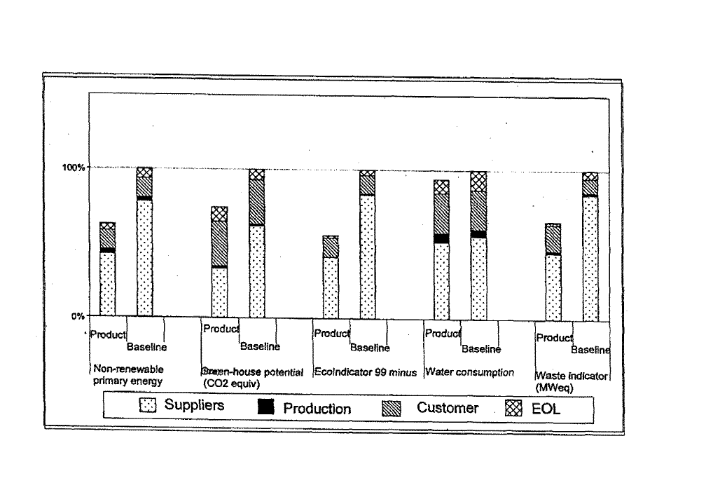

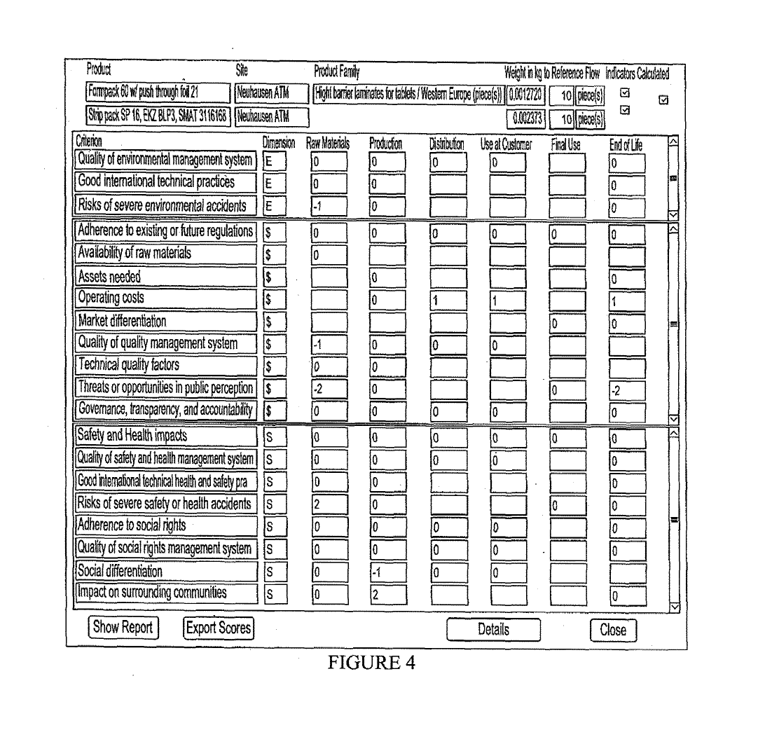

An example for the results of the scoring for selected criteria (environmental, social, economic) is given in FIG. 4. Specific weaknesses (hot-spots), i.e. where the product score is ‘−2’ in this embodiment or strengths (product score is ‘+2’) are preferably shown in color or otherwise prominently displayed for easy consideration by the user.

For the qualitative criteria the overall score of one criterion (such a criterion being e.g. “risks of severe environmental accidents”), a rational number, is then obtained by the average (may include weighting) score related to all assessed life cycle stages. In the example of FIG. 4 and this specific embodiment, the criterion “risks of severe environmental accidents” would receive an overall score of ‘−1/3’ (average of the three scores ‘−1’, ‘0’, ‘0’). Since the quantitative criteria that are represented by indicators already integrate the complete life cycle, an additional averaging is therefore not necessary for these.

The assessment principle of the social aspects works in the same way as the assessment of the environmental aspects, though usually predominantly qualitative criteria are employed, where the user scores the product in relation to the baseline as outlined for the qualitative environmental criteria (see FIGS. 2C and 2D). However, as science and experience evolves, it might be possible to represent more and more social aspects via quantitative indicators, thus leading to a more complete embodiment of social life cycle indicators in the same manner as the quantitative environmental indicators. The tool is designed in such a way that these evolving indicators can be integrated into the system. The following aggregation and weighting procedures are analogous to the assessment of the environmental aspects.

The assessment of the economic aspects is identical to the assessment of the social aspects, but according to economic criteria (see examples in FIGS. 2E and 2F).

The product sustainability assessment tool has a flexible structure, so that new or changed criteria, whether they can be quantitatively represented or whether only a qualitative nature is possible or desired, can be easily integrated, based on scientific developments and public discussions. Similarly, criteria can also be deleted if not deemed necessary anymore for an objective and holistic sustainability assessment.

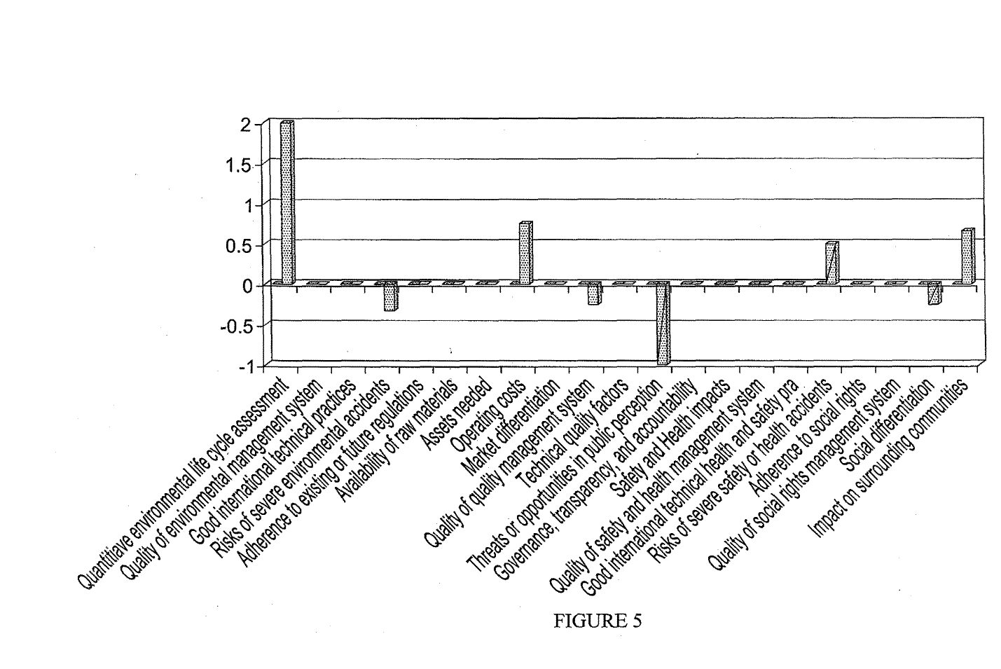

The sustainability profile is a representation of the scoring of all criteria before final weighting. An example of such a sustainability profile is given in FIG. 5.

The overall sustainability index is derived by calculating a weighted average of the three overall scores from the environmental, social, and economic aspects. The weighted average may be expressed as a percentage of difference compared to the baseline, via normalization (with −2 and 2 being -31 100% and +100%, respectively, relating to the examples given). In one embodiment of the invention, when calculating the weighted average, the three environmental, social, and economic assessment scores are given equal weights of 1/3 each.

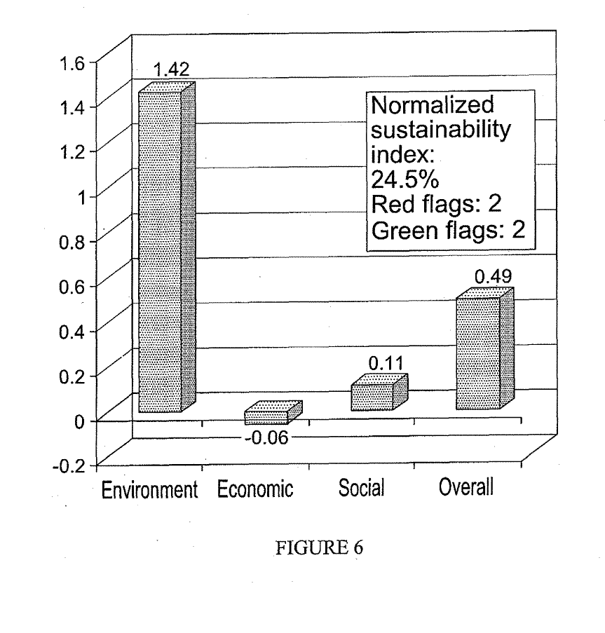

However, this index is usually accompanied by the identified hot-spots and strengths (‘−2’ and ‘2’ for the examples) from the detailed assessment to highlight the strengths and weaknesses and by the overall assessments of the three sustainability dimensions (before aggregation to overall single-score index) and the overall index before normalization. This aspect of the product sustainability assessment method and tool is illustrated in FIG. 6.

The method and tool/system of the present invention may be used by various types of users, such as product development, sales and marketing, procurement, management, etc. For product development, the method and tool can be used in a stage or phase gate or similar process (innovation, identification of needed or desired changes, anticipation of risks and opportunities for new products, improvement of existing products, etc). For sales and marketing, the tool can be used for bilateral communication with the customer (analyzing products with customers, meeting or exceeding requirements of the customer, supporting customers in better meeting the requirements of their customers, establishment of improved relationships, with customers on the basis of sustainability added value). For procurement, the tool can be used for supplier assessments and ratings (identification of preferred suppliers, communication with suppliers on requirements, etc). For internal management reporting, the tool can be used to report on trends of the development of the sustainability index for predefined product families of sites or other business entities. Additional possible applications include, but are not limited to, discussions and communications with other external parties such as policy makers, the general public, etc.

An apparatus for evaluating sustainability of a product may be provided comprising a memory, and at least one processor coupled to the memory and operative to: defining a product within a product family wherein products perform equivalent functions; defining a set of environmental, social, and economic criteria; selecting a product from said product family as a baseline for comparison; and scoring said product compared to said baseline for each of said criteria.

The embodiments of the invention described above are intended to be exemplary only. The scope of the invention is therefore intended to be limited solely by the scope of the appended claims.

1. A method for evaluating the relative sustainability of a product, the method comprising:
defining a product within a product family having products that perform equivalent functions;
defining a set of environmental, social, and economic criteria;
selecting a product from said product family as a baseline for comparison; and
scoring said product compared to said baseline for each of said criteria.

2. A method as claimed in claim 1, further comprising deriving a sustainability profile by providing scores for said environmental, social, and economic criteria.

3. A method as claimed in claim 1, further comprising deriving an overall sustainability index by calculating an average score for each of said environmental, social, and economic criteria or their representation by indicators, with weights assigned to each average score, wherein scores for said environment, social, and economic criteria and indicators are combined into a single score.

4. A method as claimed in claim 1, wherein some criteria are qualitative, and for the qualitative criteria, said scoring said product comprises assigning an individual score for each relevant stage of a life cycle of said product.

5. A method as claimed in claim 4, wherein said stages are raw materials/suppliers, production, distribution, use at customer, use at end consumer, and end of life.

6. A method as claimed in claim 4, wherein an overall score of a qualitative criterion is obtained by determining an average weighted score of all assessed life cycle stages.

7. A method as claimed in claim 1, wherein extreme scores are highlighted to indicate specific weaknesses and strengths.

8. A system for evaluating the relative sustainability of a product, the system comprising:
a processor, and
at least one application coupled to the processor and configured for:
defining a product within a product family wherein products perform an equivalent function;
defining a set of environmental, social, and economic criteria;
selecting a product from said product family as a baseline for comparison; and
scoring said product compared to said baseline for each of said criteria.

9. A system as claimed in claim 8, wherein said application is further configured for deriving a sustainability profile by providing scores for said environmental, social, and economic criteria.

10. A system as claimed in claim 8, wherein said application is further configured for deriving an overall sustainability index by calculating an average score for each of said environmental, social, and economic criteria or their representation by indicators, with weights assigned to each average score, wherein scores for said environment, social, and economic criteria and indicators are combined into a single score.

11. A system as claimed in claim 8, wherein some criteria are qualitative, and for the qualitative criteria, said scoring said product comprises assigning an individual score for each relevant stage of a life cycle of said product.

12. A system as claimed in claim 11, wherein said stages are raw materials/suppliers, production, distribution, use at customer, use at end consumer, and end of life.

13. A system as claimed in claim 11, wherein an overall score of a qualitative criterion is obtained by determining an average weighted score of all assessed life cycle stages.

14. A system as claimed in claim 8, wherein extreme scores are highlighted to indicate specific weaknesses and strengths.
